(19) United States
(12) Patent Application Publication
(10) Pub. No.: US 2007/0036387 A1
(43) Pub. Date: Feb. 15, 2007

(54) Speaker with reduced height

(75) Inventors: Jui-Cheng Chang, Taichung (TW); Yan-Shueun Peng, Changhua City (TW)

Correspondence Address: NIKOLAI & MERSEREAU, P.A., 900 SECOND AVENUE SOUTH, SUITE 820, MINNEAPOLIS, MN, 55402, US

(73) Assignee: Merry Electronics Co., Ltd., Taichung (TW)

(21) Appl. No.: 11/237,390

(22) Filed: Sep. 28, 2005

(30) Foreign Application Priority Data
Jul. 29, 2005 (TW) 94213013

(51) Int. Cl. H04R 9/06; H04R 11/02

(52) U.S. Cl. 381/396

(57) ABSTRACT

A speaker includes a body, a yoke, and two connectors. The body includes an outer periphery with a recessed section. The yoke is securely mounted around the body and engaged with the recessed section. Each connector includes a first end fixed to the yoke and a second end. Each connector is at a level not beyond an end face of the body when the speaker is in an assembled state. Thus, the speaker has a reduced height, which is particularly useful for electronic devices that have a trend in miniaturization.

### BACKGROUND OF THE INVENTION

1. Field of the Invention

The present invention relates to a speaker. In particular, the present invention relates to a speaker for electronic equipment or communication equipment.

2. Description of the Related Art

Various speakers have been developed for various products. FIGS. 5 though 7 of the drawings illustrate a conventional speaker 1 for electronic equipment or communication equipment such as mobile phones, corded or cordless phones, notebook personal computers, personal digital assistants, headphones, personal computer projectors, fax machines, etc.

The speaker 1 comprises a body 2, a yoke 3, and two connectors 4. The body 2 is a cylindrical member that is substantially U-shaped in section and comprises a compartment 9 for receiving a magnet (not shown) and a voice coil (not shown). The body 2 further comprises a rounded edge 5 on an end thereof. The yoke 3 comprises a compartment 6 for accommodating a diaphragm (not shown) and a cap (not shown). In manufacture, the yoke 3 is formed by injection molding and embraces the rounded edge 5 of the body 2. The connectors 4 are mounted on an end of the yoke 3, with each connector 4 having a first end embedded in the yoke 3 and a second end 7 for electrical connection with a circuit board (not shown) of an electronic device into which the speaker is mounted.

As illustrated in FIGS. 6 and 7, after assembly, the second ends 7 of the connectors 4 are located at a level above the top faces of the body 2 and the yoke 3. Namely, the overall height H2 of the speaker 1 is greater than the height H1 of the yoke 3. As a result, a larger space is required for mounting the speaker 1, which is adverse to the miniaturization of the equipment. Further, a transition or bend 8 between the first end and the second end 7 of each connector 4 is at an elevated state instead of in intimate contact with the yoke 3 and thus occupies the precious space in the electronic device.

### SUMMARY OF THE INVENTION

In accordance with an aspect of the present invention, a speaker comprises a body, a yoke, and two connectors. The body comprises an outer periphery with a recessed section. The body further comprises an end face. The yoke is securely mounted around the body and engaged with the recessed section. Each connector comprises a first end fixed to the yoke and a second end. Each connector is at a level not beyond the end face of the body when the speaker is in an assembled state.

In accordance with another aspect of the present invention, a speaker comprises a body, a yoke, and two connectors. The body comprises an outer periphery with a recessed section. The body further comprises an end face. The yoke is mounted around the body and bonded with the recessed section by injection molding. Each connector comprises a first end embedded in the yoke and a second end for electrical connection with a circuit board of an electronic device into which the speaker is mounted. When the speaker is mounted in the electronic device, each connector is at a level not beyond the end face of the body adjacent to which the circuit board is mounted.

Thus, the speaker in accordance with the present invention has a reduced height, which is particularly useful for electronic devices that have a trend in miniaturization.

Preferably, the body further comprises a restraining section securely bonded with the yoke for preventing the yoke from disengaging from the body. Preferably, the restraining section is a step.

Preferably, the recessed section of the body comprises a slanted portion.

Preferably, the yoke comprises two grooves for respectively receiving the connectors, and more preferably not receiving the first ends of the connectors.

Preferably, the second end of each connector is arcuate. Preferably, the second end of each connector comprises a projection.

Preferably, the yoke comprises a compartment for receiving at least one element for the speaker.

Preferably, the body comprises a compartment for receiving at least one element for the speaker.

In accordance with a further aspect of the present invention, a speaker comprises a body, a yoke, and two connectors mounted in the yoke. The body comprises an end face and an outer periphery with a reduced section. The yoke is mounted around the body and securely engaged with the reduced section to provide a space-saving effect of the speaker when the speaker is mounted in an electronic device.

Preferably, the body further comprises a restraining section securely engaged with the yoke for preventing the yoke from disengaging from the body.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a speaker in accordance with the present invention.

FIG. 2 is a sectional view taken along plane 2-2 in FIG. 1.

FIG. 3 is a sectional view similar to FIG. 2, with the speaker in an assembled state.

FIG. 4 is a sectional view taken along plane 4-4 in FIG. 3.

FIG. 5 is a perspective view of a conventional speaker.

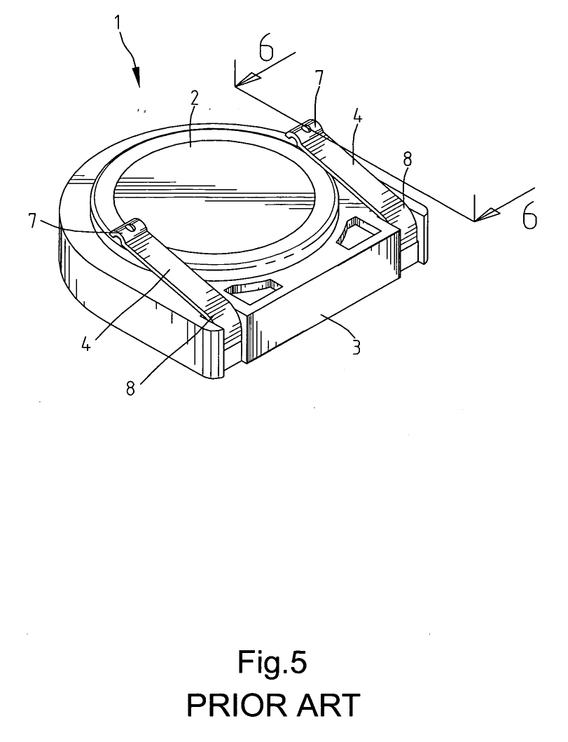

FIG. 6 is a sectional view taken along plane 6-6 in FIG. 5.

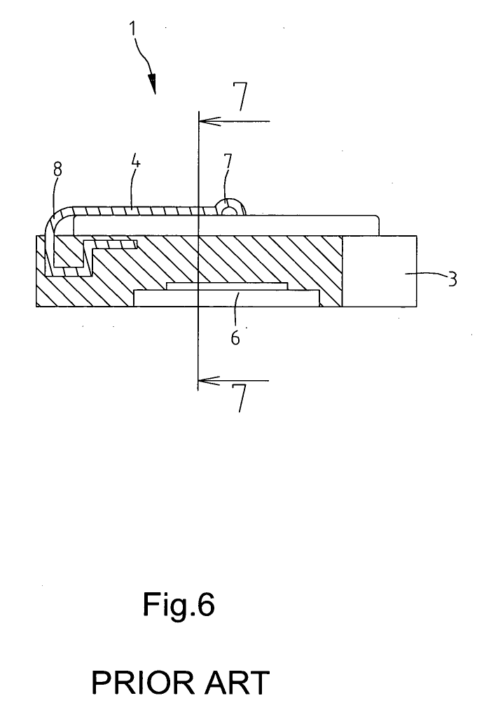

FIG. 7 is a sectional view taken along plane 7-7 in FIG. 6.

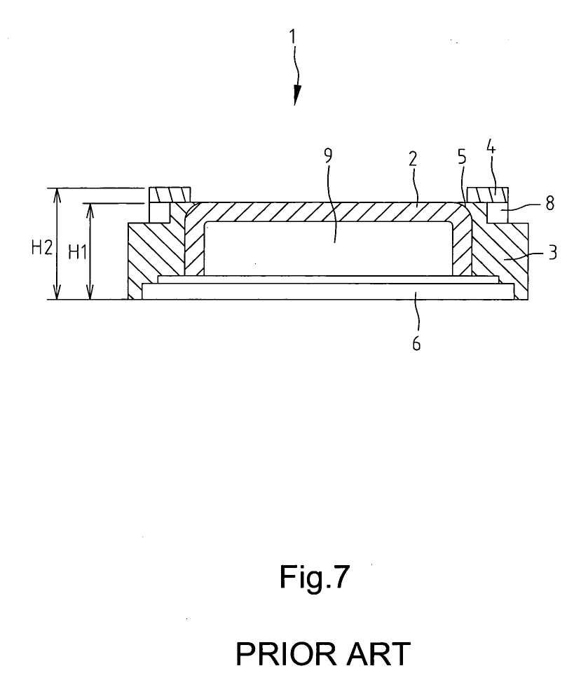

### DETAILED DESCRIPTION OF THE PREFERRED EMBODIMENT

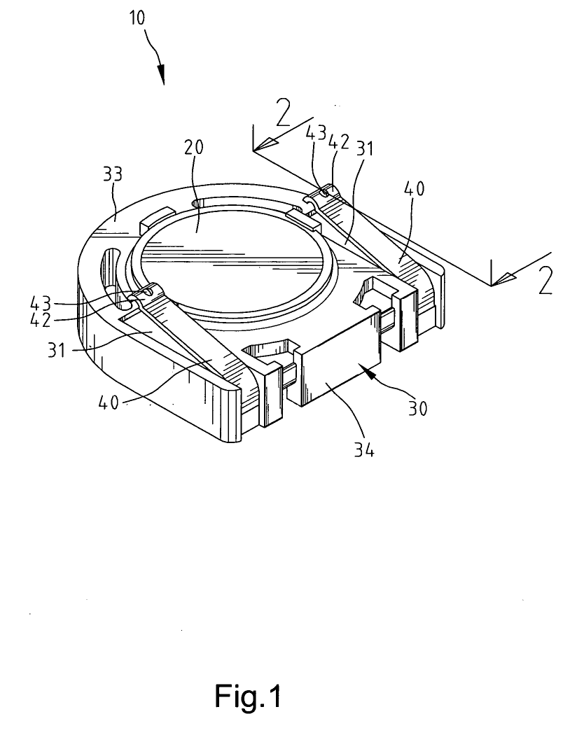

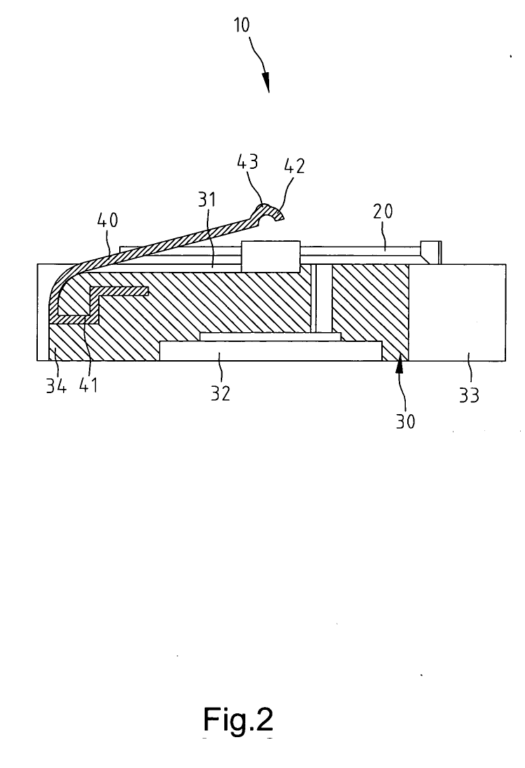

Referring to FIGS. 1 and 2, a speaker 10 in accordance with the present invention comprises a body 20, a yoke 30, and two connectors 40. The speaker 10 is mounted in an electronic device such as mobile phones, corded or cordless phones, notebook personal computers, personal digital assistants, headphones, personal computer projectors, fax machines, etc.

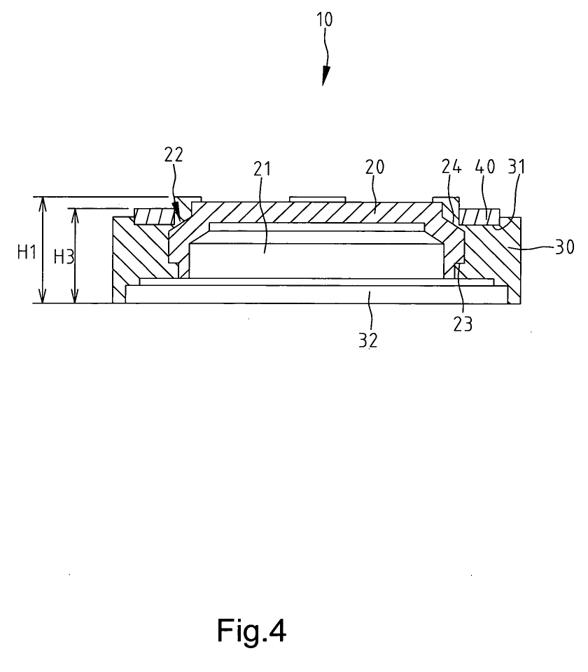

The body 20 is substantially cylindrical and comprises a compartment 21 for receiving speaker elements such as a magnet (not shown) and a voice coil (not shown) of the speaker. The body 2 further comprises a recessed section 22 on a first end of an outer periphery thereof. The body 20 further comprises a restraining section 23 on a second end of the outer periphery thereof. In the illustrated embodiment, the recessed section 22 may be a reduced section and comprises a slanted portion 24. The restraining section 23 is a step, as shown in FIG. 4. The reduced section has a cross section smaller than the cross section of the body 20 relative to a longitudinal axis of the body 20.

The yoke 30 comprises a compartment 32 for accommodating speaker elements such as a diaphragm (not shown) and a cap (not shown) of the speaker for forming a complete dynamic speaker for headphone (DSH) or dynamic type transmitter and receiver (DTR). Preferably, the compartment 32 of the yoke 30 is in communication with the compartment 21 of the body 2, as shown in FIG. 4. The yoke 30 may be formed by injection molding. In manufacture, the body 2 is placed in a mold (not shown), and molten material for the yoke 30 is poured into the mold. After hardening, the yoke 30 is bonded with the outer periphery of the body 2 and embraces the recessed section 22 and the restraining section 23 of the body 2, with an end of the body 2 located outside the yoke 30. Thus, the yoke 30 is securely bonded on the body 2 without the risk of disengagement. The recessed section 22 of the body 2 allows a reduction in an overall height of the speaker 10, providing a space-saving effect. It is noted that the yoke 30 can be formed by any other methods and assembled with the body 2 in any other manners. In the illustrated embodiment, the resultant yoke 30 comprises a first end 33 that is substantially semi-cylindrical and a second end 34 that is substantially a parallelepiped. Two grooves 31 are defined in the second end 34 of the yoke 30. Each groove 31 extends from the second end 34 toward the first end 33 of the yoke 30.

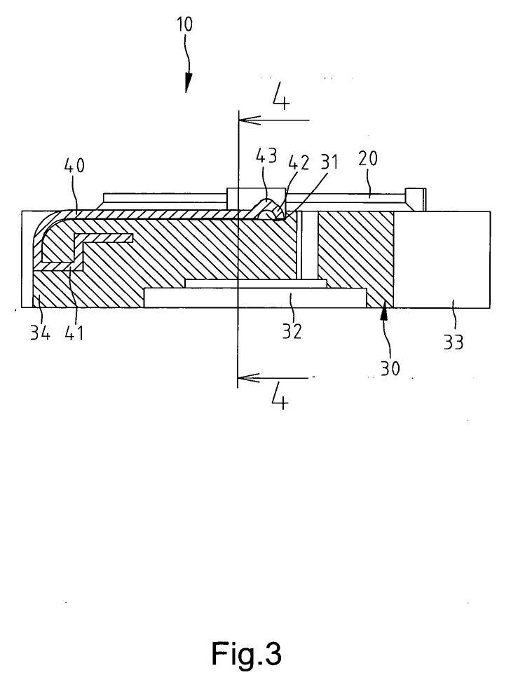

The connectors 4 are respectively mounted in the grooves 31 of the yoke 3. In the illustrated embodiment, each connector 4 includes a first end 41 embedded in the second end 34 of the yoke 30 (see FIG. 2) and a second end 42 for electrical connection with a circuit board (not shown) of the electronic device. The circuit board is generally located adjacent to an end face (the top face in FIG. 3) of the body 2. An integrated circuit (not shown) is embedded in the body 2 and comprises four contacts (not shown) two of which are electrically connected to the first ends 41 of the connectors 4, respectively. The other two contacts of the integrated circuit are electrically connected to the diaphragm. The second ends 42 of the connectors 4 are electrically connected to two contacts on the circuit board. In the illustrated embodiment, the second end 42 of each connector 4 is arcuate and includes a projection 43 for reliable electrical connection with an associated one of the contacts on the circuit board.

As illustrated in FIGS. 3 and 4, in assembly, the second ends 42 of the connectors 4 are compressed by, e.g., a housing of the electronic device toward the body 20 and completely received in the grooves 31 of the yoke 30 without projecting beyond the end face (top face) of the body 20. In other words, the second ends 42 of the connector 4 are at a level not beyond the end face (top face) of the body 20 (the height H3 from the bottom face of the yoke 30 to the second ends 42 of the connectors 40 is smaller than the overall height H1 of the yoke 30). A space-saving effect is thus obtained, as the overall height of the speaker 10 is reduced, which is advantageous to the miniaturization of the electronic device. Further, except the first end 34, each connector 40 is completely received in the associated groove 31 of the yoke 30 and in intimate contact with a bottom wall delimiting the associated groove 31 of the yoke 30, further improving the space-saving effect. Further, the yoke 30 is securely bonded with the restraining section 23 of the body 20, providing a reliable effect for preventing the yoke 30 from disengaging from the body 20.

It is noted that other arrangements of the yoke 30 and the connectors 40 are still possible without adversely affecting the space-saving effect provided by the recessed portion 22 of the body 20. For example, the grooves 31 of the yoke 30 may be omitted.

The speaker with a reduced height in accordance with the present invention is particularly useful, but not limited to, electronic equipment or communication equipment that has a trend of miniaturization, such as mobile phones, corded or cordless phones, notebook personal computers, personal digital assistants, headphones, personal computer projectors, fax machines, etc.

Although specific embodiments have been illustrated and described, numerous modifications and variations are still possible without departing from the essence of the invention. The scope of the invention is limited by the accompanying claims.

What is claimed is:

1. A speaker comprising:
a body comprising an outer periphery with a recessed section, the body further comprising an end face;
a yoke securely mounted around the body and engaged with the recessed section; and
two connectors each comprising a first end fixed to the yoke and a second end, each said connector being at a level not beyond the end face of the body when the speaker is in an assembled state.

2. The speaker as claimed in claim 1 wherein the body further comprises a restraining section securely engaged with the yoke for preventing the yoke from disengaging from the body.

3. The speaker as claimed in claim 2 wherein the restraining section is a step.

4. The speaker as claimed in claim 1 wherein the recessed section of the body comprises a slanted portion.

5. The speaker as claimed in claim 2 wherein the recessed section of the body comprises a slanted portion.

6. The speaker as claimed in claim 1 wherein the yoke comprises two grooves for respectively receiving the connectors.

7. The speaker as claimed in claim 1 wherein the second end of each said connector is arcuate.

8. The speaker as claimed in claim 7 wherein the second end of each said connector comprises a projection.

9. The speaker as claimed in claim 1 wherein the body comprises a compartment for receiving at least one element for the speaker.

10. The speaker as claimed in claim 1 wherein the yoke comprises a compartment for receiving at least one element for the speaker.

11. A speaker comprising:
a body comprising an outer periphery with a recessed section, the body further comprising an end face;
a yoke mounted around the body and bonded with the recessed section by injection molding; and
two connectors each comprising a first end embedded in the yoke and a second end adapted to be electrically connected to a circuit board of an electronic device into which the speaker is mounted, each said connector being at a level not beyond the end face of the body adjacent to which the circuit board is mounted when the speaker is mounted in the electronic device.

12. The speaker as claimed in claim 11 wherein the body further comprises a restraining section securely bonded with the yoke for preventing the yoke from disengaging from the body.

13. The speaker as claimed in claim 12 wherein the restraining section is a step.

14. The speaker as claimed in claim 11 wherein the recessed section of the body comprises a slanted portion.

15. The speaker as claimed in claim 11 wherein the yoke comprises two grooves for respectively receiving the connectors except the first ends of the connectors.

16. The speaker as claimed in claim 11 wherein the second end of each said connector comprises a projection.

17. The speaker as claimed in claim 11 wherein the yoke comprises a compartment for receiving at least one element for the speaker.

18. The speaker as claimed in claim 11 wherein the body comprises a compartment for receiving at least one element for the speaker.

19. A speaker for an electronic device, the speaker comprising:
a body comprising an end face and an outer periphery with a reduced section;
a yoke mounted around the body and securely engaged with the reduced section; and
two connectors mounted respectively in the yoke at opposite sides of the reduced section to provide a space-saving effect of the speaker when the speaker is mounted in an electronic device.

20. The speaker for an electronic device as claimed in claim 19 wherein the body further comprises a restraining section securely engaged with the yoke for preventing the yoke from disengaging from the body.
